(19) United States
(12) Patent Application Publication
(10) Pub. No.: US 2010/0273052 A1
(43) Pub. Date: Oct. 28, 2010

(54) NONAQUEOUS ELECTROLYTE SECONDARY BATTERY AND METHOD FOR MANUFACTURING THE SAME

(75) Inventors: Nobuhiro Sakitani, Osaka (JP); Naoki Imachi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-city, Osaka (JP)

(21) Appl. No.: 12/746,835

(22) PCT Filed: Dec. 24, 2008
(86) PCT No.: PCT/JP2008/003929

§ 371 Date: Jun. 8, 2010

(30) Foreign Application Priority Data
Jan. 10, 2008 (JP) 2008-002836
Mar. 3, 2008 (JP) 2008-051501
May 27, 2008 (JP) 2008-138069

(51) Int. Cl. H01M 4/62; H01M 4/82

(52) U.S. Cl. 429/217; 29/623.5

(57) ABSTRACT

A nonaqueous electrolyte secondary battery using electrodes including a mixture layer formed on a current collector by using an aqueous slurry is provided to enable efficient battery production, have a high adhesion strength in the electrode and enable improved battery performance. The nonaqueous electrolyte secondary battery includes a positive electrode, a negative electrode and a nonaqueous electrolyte, wherein at least one of the positive and negative electrodes is an electrode obtained by: forming a precoat layer 6 made of a latex binder and an aqueous dispersant on a current collector 1; forming a mixture layer 2 on the precoat layer 6 by applying an aqueous slurry containing an active material, a latex binder and an aqueous dispersant to the precoat layer 6; and drying the mixture layer 2.

### TECHNICAL FIELD

This invention relates to nonaqueous electrolyte secondary batteries, such as lithium secondary batteries, and methods for manufacturing the same.

### BACKGROUND ART

Lithium ion secondary batteries are widely used as power sources for driving portable devices because of their small size and lightweight characteristics. In recent years, the use of lithium ion secondary batteries has been expected to extend to other applications, such as electric tools, electric power-assisted bicycles, and even HEVs. The demand for lithium ion secondary batteries is ever growing. However, the decline in their prices has become greater year by year than the increase in their production volume. Now a responsibility of battery makers is to establish production systems to meet cost reduction requirement and market demand.

A manufacturing process for batteries is divided into an electrode production process, an electrode winding process, a electrolyte filling process, and an inspection process. A matter of importance in the electrode production process is how the application of a slurry to a current collector and the drying of the slurry can be speeded up. To speed up drying, the drying temperature may preferably be elevated. However, the slurry for producing an electrode contains a plurality of ingredients in a mixture. In order to raise the electrode quality, it is necessary to produce an electrode having a homogeneous composition in the thickness direction of the electrode. If the electrode composition is inhomogeneous, the electrode may cause (1) variations in electric resistance and (2) variations in adhesion density of the electrode. If the drying temperature for the slurry is elevated, the composition of the electrode in the thickness direction may become inhomogeneous.

In recent years, from the viewpoint of environmental health, there has been a particular demand for an aqueous slurry using no organic solvent as a slurry for producing an electrode. The inventors have found that in producing an electrode using such an aqueous slurry, if the drying temperature is elevated, there arises a problem in which the strength of adhesion of a mixture layer to a current collector may be significantly lowered. Patent Document 1 proposes, as an approach for improving the adhesion between the mixture layer and the current collector, to previously apply a thin film containing the same ingredients as the mixture layer of the negative electrode to the surface of the current collector to form the thin film, thereby improving the adhesion. Furthermore, Patent Documents 2 and 3 propose to form a polymer compound layer having an electron conductivity between an negative-electrode active material layer and a current collector. However, these conventional techniques are intended to improve the adhesion in producing an electrode using a solvent-based slurry or reduce the contact resistance, and not intended to lessen the reduction in adhesion strength caused by elevating the drying temperature with the use of an aqueous slurry.
Patent Document 1: Published Japanese Patent Application No. H11-86850
Patent Document 2: Published Japanese Patent Application No. H05-135759
Patent Document 3: Published Japanese Patent Application No. H03-165458

### DISCLOSURE OF THE INVENTION

An object of the present invention is that a nonaqueous electrolyte secondary battery using electrodes including a mixture layer formed on a current collector by using an aqueous slurry is provided to enable efficient battery production, have a high adhesion strength in the electrode and enable improved battery performance, and that a method for manufacturing the same is provided.

A nonaqueous electrolyte secondary battery according to the present invention is a nonaqueous electrolyte secondary battery including a positive electrode, a negative electrode and a nonaqueous electrolyte, wherein at least one of the positive electrode and the negative electrode is an electrode obtained by: forming a precoat layer made of a latex binder and an aqueous dispersant on a current collector; forming a mixture layer on the precoat layer by applying an aqueous slurry containing an active material, a latex binder and an aqueous dispersant to the precoat layer; and drying the mixture layer.

The inventors studied the reason why an electrode having a mixture layer formed on a current collector by using an aqueous slurry lowers the adhesion strength when the drying temperature is elevated. As a result, the inventors have found that the reason is that the binder contained in the mixture layer migrates owing to thermal convection produced in the mixture layer during drying and is eccentrically located in the surface of the mixture layer.

FIG. 2 shows cross-sectional views for illustrating migration of a binder in a mixture layer due to convection. As shown in FIG. 2(a), a mixture layer 2 is disposed on a current collector 1, and a binder 3 in the mixture layer 2 migrates upward owing to convection flows 5 produced in the mixture layer 2 when dried by application of hot air 4. It has been found from this that as shown in FIG. 2(b), the binder 3 is eccentrically located in the surface of the mixture layer 2, and the amount of binder in the interface between the current collector 1 and the mixture layer 2 decreases, whereby the adhesion strength of the mixture layer 2 to the current collector 1 is lowered.

As shown in FIG. 1, according to the present invention, a precoat layer 6 made of a latex binder and an aqueous dispersant is formed on a current collector 1, a mixture layer 2 is formed on the precoat layer 6 by applying an aqueous slurry containing an active material, a latex binder and an aqueous dispersant to the precoat layer 6, and these materials are dried, thereby producing an electrode. In the present invention, the electrode thus obtained is used as at least one of the positive and negative electrodes.

According to the present invention, since the precoat layer made of a latex binder and an aqueous dispersant is formed between the current collector and the mixture layer, the concentration of the latex binder in the interface between the current collector and the mixture layer can be maintained at a high level even if the latex binder in the mixture layer migrates to the surface of the mixture layer during drying of the mixture layer. Therefore, the adhesion strength can be increased. In addition, since the drying temperature can be elevated, the electrode can be efficiently produced.

Furthermore, since the adhesion strength in the electrode can be increased, the battery performance can be improved to provide high reliability. The active material shows significant changes in expansion and shrinkage involved in charging and discharging, and the electrode is therefore likely to be subjected to stress. Repeating such charging and discharging may cause peel-off of the active material from the electrode. According to the present invention, since the adhesion strength can be increased, such peel-off of the active material can be prevented. Therefore, the battery performance can be improved, whereby the long-term reliability can be increased.

In the present invention, the latex binder in the precoat layer is not necessarily the same as that in the mixture layer. However, if the latex binder used for the precoat layer is the same as that for the mixture layer, the composition of the electrode can be more homogeneous, which further increases the adhesion strength. Specifically, the latex binder in the precoat layer preferably has the same composition and composition ratio as that in the mixture layer, and more preferably has the same composition, composition ratio and degree of polymerization as that in the mixture layer.

Furthermore, in the present invention, the aqueous dispersant in the precoat layer is not necessarily the same as that in the mixture layer. However, if the aqueous dispersant used for the precoat layer is the same as that for the mixture layer, the composition of the electrode can be more homogeneous, which further increases the adhesion strength. Specifically, the aqueous dispersant in the precoat layer preferably has the same composition and composition ratio as that in the mixture layer, and more preferably has the same composition, composition ratio and degree of polymerization as that in the mixture layer.

More specifically, for example, both the aqueous dispersants for the precoat and mixture layers are preferably carboxymethyl cellulose dispersants, more preferably carboxymethyl cellulose dispersants having the same degree of polymerization, and still more preferably carboxymethyl cellulose dispersants having the same degree of polymerization and the same degree of etherification.

The latex binder used in the present invention is not particularly limited and may be any material that can be used as a binder in an aqueous slurry containing an active material. Specific examples of the latex binder include styrene-butadiene latex, acrylonitrile-butadiene latex, acrylic acid ester latexes, vinyl acetate latexes, methylmethacrylate-butadiene latex, and their carboxy-modified latexes.

Any aqueous dispersant can be used as the aqueous dispersant in the present invention without limit except that it is an aqueous dispersant that can be contained in an aqueous slurry containing an active material. Specific examples of the aqueous dispersant include carboxymethyl cellulose.

The degree of etherification of carboxymethyl cellulose used as the aqueous dispersant is preferably in the range of 0.5 to 0.8, more preferably in the range of 0.6 to 0.8, and still more preferably in the range of 0.65 to 0.75. If the degree of etherification of carboxymethyl cellulose is 0.8 or less, the adhesion strength of the electrode can be further increased. If the degree of etherification of carboxymethyl cellulose is below 0.5, the solubility of carboxymethyl cellulose in water tends to decrease.

The weight ratio between the latex binder and the aqueous dispersant in the precoat layer (Latex Binder to Aqueous

Dispersant) is preferably in the range of 0.5:1 to 10:1, and more preferably in the range of 1:1 to 5:1. If the ratio of the latex binder in the precoat layer is high, the adhesion strength of the mixture layer tends to increase, but the tackiness of the surface of the precoat layer also tends to increase, whereby the subsequent mixture layer production step is prone to problems. On the other hand, if the ratio of the latex binder in the precoat layer is low, the adhesion strength tends to decrease. Therefore, the weight ratio between the latex binder and carboxymethyl cellulose is preferably in the range of 0.5:1 to 10:1, and more preferably in the range of 1:1 to 5:1.

In the present invention, the thickness of the precoat layer is preferably 1 μm or less. If the thickness of the precoat layer is above 1 μm, the electrode obtained by forming a mixture layer on the precoat layer and drying the mixture layer may offer insufficient contact between the active material in the mixture layer and the current collector, which may prevent good current collectivity. The lower limit of the thickness of the precoat layer is not particularly limited, but is generally preferably 0.01 μm or more. If the thickness of the precoat layer is too small, the effect of increasing the adhesion strength according to the present invention may not sufficiently be achieved. Therefore, the thickness of the precoat layer is preferably in the range of 0.01 to 1 μm and more preferably in the range of 0.1 to 1 μm.

The process of applying the precoat layer in the present invention is not particularly limited. An example of the process is a gravure coating process. By application using a gravure coating process, a precoat layer can be formed which has a uniform thickness even if it is thin.

The electrode in which the precoat layer is formed according to the present invention may be one or both of a positive electrode and a negative electrode. In recent years, the use of an aqueous slurry in producing a negative electrode has been considered. The present invention is applicable to the formation of such a negative electrode using an aqueous slurry. However, the present invention is also applicable to the production of a positive electrode using an aqueous slurry.

The negative-electrode active material used is not particularly limited, and may be any material that can be used as a negative-electrode active material in a lithium ion secondary battery. Examples of the negative-electrode active material include graphite, coke, tin oxide, metal lithium, silicon, and their mixtures.

The positive-electrode active material used is also not particularly limited so long as it is a positive-electrode active material that can be used in a lithium ion secondary battery. Examples of the positive-electrode active material include lithium-containing transition metal oxides, such as lithium cobaltate. Specific examples of the positive-electrode active material other than lithium cobaltate include nickel-containing lithium composite oxides, such as Ni—Co—Mn-containing lithium composite oxides, Ni—Mn—Al-containing lithium composite oxides and Ni—Co—Al-containing lithium composite oxides, spinel-type lithium manganate, and olivine-type lithium iron phosphate.

In the present invention, the total concentration of the latex binder and the aqueous dispersant in the aqueous solution for forming a precoat layer is appropriately controlled depending on the types of the latex binder and aqueous dispersant used, and can generally be controlled to be in the range of 0.2% to 15% by weight.

The nonaqueous electrolyte in the present invention is not particularly limited, and any nonaqueous electrolyte can be used so long as it can be used for a lithium ion secondary battery.

Examples of the solute for the nonaqueous electrolyte include LiBF₄, LiPF₆, LiN(SO₂CF₃)₂, LiN(SO₂C₂F₅)₂, and LiPF₆₋ₓ(CₙF₂ₙ₊₁)ₓ where 1<x<6 and n=1 or 2. These materials can be used singly or in a mixture of two or more of them.

Examples of the solvent for the nonaqueous electrolyte secondary battery that can be used include ethylene carbonate (EC), propylene carbonate (PC), γ-butylolactone (GBL), diethyl carbonate (DEC), ethyl methyl carbonate (EMC), and dimethyl carbonate (DMC). The solvent is preferably used in a combination of a cyclic carbonate and a chain carbonate.

The concentration of the solute in the nonaqueous electrolyte is not particularly limited. Examples of the concentration include concentrations of 0.8 to 1.8 mol/L.

A manufacturing method according to the present invention is a method capable of manufacturing the above nonaqueous electrolyte secondary battery of the present invention, and is characterized by including the steps of: forming a precoat layer on a current collector; and forming a mixture layer on the precoat layer by applying an aqueous slurry containing an active material, a latex binder and an aqueous dispersant to the precoat layer and then drying the mixture layer.

The method for manufacturing a nonaqueous electrolyte secondary battery according to the present invention is characterized by including the above-described method of producing an electrode. Therefore, the electrode obtained by the above producing method has a high adhesion strength in the electrode and can improve the battery performance. Furthermore, since after the application of the aqueous slurry the mixture layer can be dried at a high drying temperature, the electrode can be efficiently produced.

The drying temperature during drying after the application of the aqueous slurry is not particularly limited. Examples of the drying temperature include temperatures ranging from 40° C. to 150° C.

After the mixture layer is formed on the precoat layer in the above manner, the electrode is preferably rolled in the same manner as in the normal electrode production process. By such a rolling step, the active material in the mixture layer can be brought into efficient contact with the current collector, thereby increasing the current collectivity.

### Effects of the Invention

According to the present invention, a nonaqueous electrolyte secondary battery using electrodes including a mixture layer formed on a current collector by using an aqueous slurry enables efficient battery production, has a high adhesion strength in the electrode, and enables improved battery performance.

### BRIEF DESCRIPTION OF DRAWINGS

FIG. 1 is a cross-sectional view showing a state in which according to the present invention, a precoat layer is formed on a current collector and a mixture layer is formed on the precoat layer.

FIG. 2 shows cross-sectional views for illustrating a state of a conventional electrode in which a binder migrates to the surface of a mixture layer owing to a drying process.

FIG. 3 is an electron micrograph showing a cross section of an electrode.

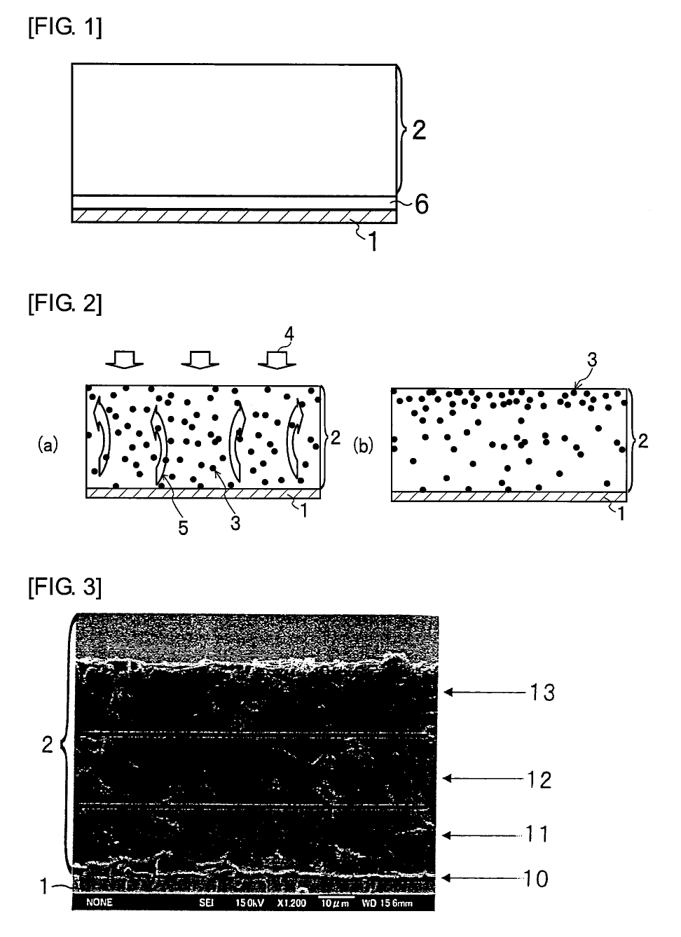

### LIST OF REFERENCE NUMERALS

1 . . . current collector

2 . . . mixture layer

3 . . . binder

4 . . . hot air

5 . . . convection flow

6 . . . precoat layer

10 . . . interface

11 . . . lower layer

12 . . . middle layer

13 . . . upper layer

### BEST MODE FOR CARRYING OUT THE INVENTION

Hereinafter, the present invention will be described in more detail. However, the present invention is not at all limited by the following examples, and can be embodied in various other forms appropriately modified without changing the spirit of the invention.

### Example 1

[Production of Negative Electrode]

Carboxymethyl cellulose (CMC: Grade “1380” manufactured by Daicel Chemical Industries, Ltd. and having a degree of etherification of 1.0 to 1.5) was dissolved in pure water to a concentration of 1% by weight. To the CMC aqueous solution was added a styrene-butadiene rubber (SBR) latex to give a solid weight ratio (CMC:SBR) of 1:1, followed by mixing.

The CMC-SBR aqueous solution thus prepared was applied to both the surfaces of a piece of copper foil serving as a current collector at a rate of 1.0 m/min with a 150° mesh gravure roll, and then dried by passage through a first drying chamber (at 70° C.) and a second drying chamber (at 105° C.), thereby forming precoat layers. The spread of the precoat layers on both the surfaces of the piece of copper foil was set at 0.5 mg/10 cm², and the thickness of the precoat layer on each surface was set at 0.2 μm.

Next, artificial graphite serving as a negative-electrode active material, CMC 1380 (the same material as above) and SBR were mixed in pure water to give a weight ratio (Active Material to CMC to SBR) of 98:1:1, thereby preparing an aqueous slurry. Next, the aqueous slurry was applied to both the surfaces of the piece of copper foil on which the precoat layers were formed, thereby forming mixture layers. The mixture layers thus formed were dried using continuous drying chambers with a total length of 4 m. The temperature in a first drying chamber (with a length of 2 m) was set at 115° C., and the drying temperature in a second drying chamber (with a length of 2 m) was set at 120° C. In these conditions, the piece of copper foil was passed through the drying chambers at a rate of 1.5 m/min, thereby drying the mixture layers. Thereafter, the mixture layers were rolled to a packing density of 1.60 g/ml. The electrode thus obtained will hereinafter be referred to as Inventive Negative Electrode t.

[Production of Positive Electrode]

Lithium cobaltate serving as a positive-electrode active material, acetylene black serving as a conductive carbon material, and poly(vinylidene fluoride) (PVDF) serving as a binder were mixed in N-methylpyrrolidinone (NMP) to give a weight ratio (Active Material to Conductive Material to Binder) of 95:2.5:2.5, thereby preparing a slurry for producing a positive electrode.

The above slurry for producing a positive electrode was applied on both the surfaces of a piece of aluminium foil, dried and then rolled to a packing density of 3.60 g/ml.

[Preparation of Nonaqueous Electrolytic Solution]LiPF₆ was dissolved in a mixed solvent of ethylene carbonate (EC) and diethyl carbonate (DEC) having a volume ratio of 3:7 to give a concentration of 1.0 mol per liter of the solvent, and the resultant mixture was used as a nonaqueous electrolytic solution.

[Assembly of Battery]

Individual lead terminals were attached to the positive and negative electrodes, and the electrodes are stacked with a separator (made from polyethylene and having a film thickness of 16 μm and a porosity of 47%) interposed therebetween. Then, these components were spirally wound and pressed down in a flattened form to produce an electrode assembly. The electrode assembly was placed into an aluminum laminate serving as a battery outer package. The aluminum laminate was then filled with the above nonaqueous electrolytic solution, followed by sealing of the aluminum laminate, thereby producing a lithium ion secondary battery (Inventive Battery T). The design capacity of the battery is 750 mAh. Note that the battery design capacity was designed with reference to an end-of-charge voltage of 4.20 V.

### Example 2

A negative electrode was produced in the same manner as in Example 1 except that carboxymethyl cellulose (CMC 1380) and styrene-butadiene rubber (SBR) were mixed to give a solid weight ratio (CMC:SBR) of 1:3, followed by formation of precoat layers. The negative electrode will hereinafter be referred to as Inventive Negative Electrode t2. Inventive Battery T2 was produced in the same manner as in Example 1 except for the use of the above Inventive Negative Electrode t2.

### Example 3

A negative electrode was produced in the same manner as in Example 1 except that carboxymethyl cellulose (CMC 1380) and styrene-butadiene rubber (SBR) were mixed to give a solid weight ratio (CMC:SBR) of 1:5, followed by formation of precoat layers. The negative electrode will hereinafter be referred to as Inventive Negative Electrode t3. Inventive Battery T3 was produced in the same manner as in Example 1 except for the use of the above Inventive Negative Electrode t3.

### Example 4

A negative electrode was produced in the same manner as in Example 1 except that carboxymethyl cellulose (CMC: Grade “BSH-12” manufactured by Dai-ichi Kogyo Seiyaku Co., Ltd. and having a degree of etherification of 0.65 to 0.75) was dissolved in pure water to a concentration of 0.5% by weight, a styrene-butadiene rubber (SBR) latex was added to the CMC aqueous solution to give a solid weight ratio (CMC:SBR) of 1:3, the solution was mixed to obtain a CMC-SBR aqueous solution, and the obtained CMC-SBR solution was used to form precoat layers. The negative electrode will hereinafter be referred to as Inventive Negative Electrode t4.

### Example 5

A negative electrode was produced in the same manner as in Example 2 except that carboxymethyl cellulose (CMC: Grade “BSH-12” manufactured by Dai-ichi Kogyo Seiyaku Co., Ltd. and having a degree of etherification of 0.65 to 0.75) was used to prepare an aqueous slurry used for the formation of mixture layers. The negative electrode will hereinafter be referred to as Inventive Negative Electrode t5.

### Example 6

A negative electrode was produced in the same manner as in Example 5 except that carboxymethyl cellulose (CMC: Grade “BSH-12” manufactured by Dai-ichi Kogyo Seiyaku Co., Ltd. and having a degree of etherification of 0.65 to 0.75) was dissolved in pure water to a concentration of 0.5% by weight, a styrene-butadiene rubber (SBR) latex was added to the CMC aqueous solution to give a solid weight ratio (CMC:SBR) of 1:3, the solution was mixed to obtain a CMC-SBR aqueous solution, and the obtained CMC-SBR solution was used to form precoat layers. The negative electrode will hereinafter be referred to as Inventive Negative Electrode t6.

### Comparative Example 1

A negative electrode was produced in the same manner as in Example 1 except that no precoat layer was formed. The negative electrode will hereinafter be referred to as Comparative Negative Electrode r1. Comparative Battery R1 was produced in the same manner as in Examples except for the use of the above Comparative Negative Electrode r1.

### Comparative Example 2

A negative electrode was produced in the same manner as in Example 1 except that precoat layers were formed from a 1% by weight CMC aqueous solution containing only CMC 1380. The negative electrode will hereinafter be referred to as Comparative Negative Electrode r2.

### Comparative Example 3

A negative electrode was produced in the same manner as in Example 1 except that precoat layers were formed from a 1% by weight SBR aqueous solution containing only SBR. The negative electrode will hereinafter be referred to as Comparative Negative Electrode r3.

### Comparative Example 4

A negative electrode was produced in the same manner as in Comparative Example 1 except that the drying temperature in the first drying chamber (with a length of 2 m) was set at 60° C., that the drying temperature in the second drying chamber (with a length of 2 m) was set at 110° C., and that in these conditions the piece of copper foil was passed through the drying chambers at a rate of 1 m/min to dry it. Therefore, in this case, a negative electrode was produced without the formation of precoat layers. The negative electrode will hereinafter be referred to as Comparative Negative Electrode r4.

### Comparative Example 5

A negative electrode was produced in the same manner as in Example 5 except that no precoat layer was formed. The negative electrode will hereinafter be referred to as Comparative Negative Electrode r5.

[Observation of Binder Distribution State]

Observation was made of the distribution state of the binder in the mixture layers of Comparative Negative Electrode r1 in the following manner.

A cross section of Comparative Negative Electrode r1 after being rolled was produced with a cross section polisher (“SM-09010” manufactured by JEOL Ltd.). On a petri dish wad dropped 0.3 ml of 2% by weight aqueous solution of OsO₄, and the negative electrode having the produced cross section was put on the petri dish near to the solution so as to avoid direct contact with the solution. Then, the lid of the petri dish was closed, followed by standing for two hours, whereby Os was absorbed by double bonds of the binder contained in the mixture layers of the negative electrode. In other words, the distribution of Os was measured by taking advantage of the fact that the double bond can be oxidized with Os, whereby the distribution of the binder in the inside of the electrode was indirectly measured. The measurement was made with an EDX (“JSM-6500F” manufactured by JEOL Ltd.).

FIG. 3 is an electron micrograph showing a cross section of the negative electrode. A portion of the electrode located above the interface 10 between the current collector 1 and the mixture layer 2 was measured for distribution of double bonds. Each of parts of the mixture layer 2 including an upper layer 13, a middle layer 12 and a lower layer 11 was measured for proportion of double bonds (%), and the results are shown in TABLE 1.

TABLE 1

| | Proportion of |
|---|---|
| | Presence of Binder (%) |
| Upper Layer | 44 |
| Middle Layer | 33 |
| Lower Layer | 23 |

As seen from TABLE 1, it was confirmed that the proportion of presence of the binder was not uniform over the entire mixture layer, the middle layer had a higher proportion than the lower layer, the upper layer had a higher proportion than the middle layer, and the binder was eccentrically located near the surface of the mixture layer.

[Measurement of Thickness of Precoat Layer]

As for Examples 1 to 3, the thicknesses of their precoat layers were measured in the following manner. After the precoat layer was formed on the current collector of the negative electrode, a gold-coated layer was formed on the precoat layer with a SPUTTER COATER (SC7640) manufactured by VG Microtech. A cross section of the negative electrode was produced with a cross section polisher (SM-09010) manufactured by JEOL Ltd., and the gap between the current collector layer and the gold-coated layer was measured with a SEM (JSM-6500F) manufactured by JEOL Ltd., thereby measuring the thickness of the precoat layer. TABLE 3 shows the measurement results on the thicknesses of the precoat layers of Examples 1 to 3. As seen from TABLE 3, it was confirmed that in all of Examples 1 to 3, the precoat layers with a thickness of 0.2 μm were formed.

[Evaluation for Adhesion Strength of Negative Electrode]

Inventive Negative Electrode t and Comparative Negative Electrodes r1 to r4 were evaluated for adhesion strength in the following manner. A round test specimen to which a 3 cm² adhesive tape (Scotch Double-Coated Tape 666 manufactured by 3M) was attached was pressed against the surface of the mixture layer of each negative electrode. Using a compression/tension testing machine (“SV-5” and “DRS-5R” manufactured by Imada Seisakusho Co., Ltd.), the test specimen was pulled up from the electrode at a constant rate (300 mm/min), and measured for maximum strength when the mixture layer was peeled off. The measurement results are shown in TABLE 2.

TABLE 2

| | | Adhesion Strength (kg) |
|---|---|---|
| Inventive Negative | CMC + SBR | 0.99 |
| Electrode t | | |
| Comparative Negative | — | 0.53 |
| Electrode r1 | | |
| Comparative Negative | CMC | 0.22 |
| Electrode r2 | | |
| Comparative Negative | SBR | Not Measured |
| Electrode r3 | | |
| Comparative Negative | Low-Temperature | 0.71 |
| Electrode r4 | Drying | |

As shown in TABLE 2, Inventive Negative Electrode t produced by forming precoat layers and then forming mixture layers on the precoat layers according to the present invention obtained a higher adhesion strength than Comparative Negative Electrode r1 produced without the formation of precoat layers. Furthermore, comparison between Comparative Negative Electrode r4 dried at a low temperature and Comparative Negative Electrode r1 shows that Comparative Negative Electrode r4 dried at a low temperature obtained a higher adhesion strength. These results show that the drying at a high temperature causes the binder to migrate in the mixture layer to thereby lower the adhesion strength. Furthermore, Comparative Negative Electrode r2 using only CMC for precoat layers exhibited a significantly low adhesion strength. Moreover, Comparative Negative Electrode r3 using only SBR for precoat layers exhibited tackiness on the surfaces of the mixture layers and thereby could not form good coated surfaces. Therefore, Comparative Negative Electrode r3 could not be measured for adhesion strength.

Inventive Negative Electrodes t2 and t3 were also measured for adhesion strength in the same manner as described above.

Furthermore, besides the evaluation for adhesion strength of the negative electrodes using the above-described 180 degree peel test, Inventive Negative Electrodes t2 and t3 and Comparative Negative Electrode r1 were measured for adhesion strength using the following 90 degree peel test.

Each negative electrode measuring 100 mm×25 mm was attached onto a 120 mm×30 mm acrylic plate through a 70 mm×20 mm adhesive double-faced tape (“NAISTAK NW-20” manufactured by Nichiban Co., Ltd.). An end of the negative electrode attached to the acrylic plate was pulled 50 mm upward from and at a right angle with the surface of the mixture layer at a constant rate (100 mm/min) by a small desktop testing machine (“FGS-TV” and “FGP-5” manufactured by Nidec-Shimpo Corporation), thereby measuring the average strength when the mixture layer was peeled off. The measurement results are shown in TABLE 3 together with the results shown in TABLE 2.

TABLE 3

| | | Precoat Layer Thickness | Adhesion Strength (kg) | Adhesion Strength (mN) |
|---|---|---|---|---|
| | | (μm) | (180 Degree Peel) | (90 Degree Peel) |
| Inventive Negative | CMC:SBR = 1:1 | 0.2 | 0.99 | 85.0 |
| Electrode t | | | | |
| Inventive Negative | CMC:SBR = 1:3 | 0.2 | 1.16 | 137.8 |
| Electrode t2 | | | | |
| Inventive Negative | CMC:SBR = 1:5 | 0.2 | 1.19 | 130.7 |
| Electrode t3 | | | | |
| Comparative Negative | — | — | 0.53 | 83.0 |
| Electrode r1 | | | | |
| Comparative Negative | Only CMC | Not Measured | 0.22 | Not Measured |
| Electrode r2 | | | | |
| Comparative Negative | Only SBR | Not Measured | Not Measured | Not Measured |
| Electrode r3 | | | | |
| Comparative Negative | Low-Temperature | — | 0.71 | Not Measured |
| Electrode r4 | Drying | | | |

As shown in TABLE 3, both the evaluation results of 180 degree and 90 degree peel tests show the same tendency. Specifically, Inventive Negative Electrodes t, t2 and t3 produced by forming precoat layers and then forming mixture layers on the precoat layers according to the present invention obtained higher adhesion strengths than Comparative Negative Electrode r1 produced without the formation of precoat layers. Furthermore, the measurement results on Inventive Negative Electrodes t, t2 and t3 show that as the proportion of SER contained in the precoat layer increased, the adhesion strength also increased.

From these results, it can be seen that as the ratio of the latex binder in the precoat layer increases, the adhesion strength of the mixture layer of the negative electrode tends to increase, but the tackiness of the surface of the precoat layer also increases, whereby the subsequent mixture layer production step is prone to problems. Therefore, it can be seen that from the viewpoint of maintaining the tackiness of the surface of the precoat layer at a low level while increasing the adhesion strength, the weight ratio between the latex binder and carboxymethyl cellulose is particularly preferably in the range of 1:1 to 5:1.

Furthermore, Inventive Negative Electrodes t4 to t6 and Comparative Negative Electrode r5 were also evaluated for adhesion strength using the above-described 90 degree peel test. The evaluation results are shown in the following TABLE 4 together with the results on the other Inventive and Comparative Negative Electrodes.

TABLE 4

| | | CMC Type (Degree of Etherification) | Adhesion Strength (kg) | Adhesion Strength (mN) |
|---|---|---|---|---|
| | | Mixture Layer/Precoat Layer | (180 Degree Peel) | (90 Degree Peel) |
| Inventive Negative | CMC:SBR = 1:1 | 1380(1.0~1.5)/1380(1.0~1.5) | 0.99 | 85.0 |
| Electrode t | | | | |
| Inventive Negative | CMC:SBR = 1:3 | 1380(1.0~1.5)/1380(1.0~1.5) | 1.16 | 137.8 |
| Electrode t2 | | | | |
| Inventive Negative | CMC:SBR = 1:5 | 1380(1.0~1.5)/1380(1.0~1.5) | 1.19 | 130.7 |
| Electrode t3 | | | | |
| Inventive Negative | CMC:SBR = 1:3 | 1380(1.0~1.5)/BSH12(0.65~0.75) | Not Measured | 108.5 |
| Electrode t4 | | | | |
| Inventive Negative | CMC:SBR = 1:3 | BSH12(0.65~0.75)/1380(1.0~1.5) | Not Measured | 252.0 |
| Electrode t5 | | | | |
| Inventive Negative | CMC:SBR = 1:3 | BSH12(0.65~0.75)/BSH12(0.65~0.75) | Not Measured | 282.4 |
| Electrode t6 | | | | |
| Comparative Negative | — | 1380(1.0~1.5)/— | 0.53 | 83.0 |
| Electrode r1 | | | | |
| Comparative Negative | Only CMC | 1380(1.0~1.5)/1380(1.0~1.5) | 0.22 | Not Measured |
| Electrode r2 | | | | |
| Comparative Negative | Only SBR | 1380(1.0~1.5)/— | Not Measured | Not Measured |
| Electrode r3 | | | | |
| Comparative Negative | Low-Temperature | 1380(1.0~1.5)/1380(1.0~1.5) | 0.71 | Not Measured |
| Electrode r4 | Drying | | | |
| Comparative Negative | — | BSH12(0.65~0.75)/— | Not Measured | 179.2 |
| Electrode r5 | | | | |

As shown in TABLE 4, the adhesion strength of Inventive Negative Electrode t4 using different types of carboxymethyl cellulose for the mixture and precoat layers was higher than that of Comparative Negative Electrode r1 having no precoat layer formed, but was lower than that of Inventive Negative Electrode t2 using the same type of carboxymethyl cellulose for the mixture and precoat layers. Similarly, the adhesion strength of Inventive Negative Electrode t5 using different types of carboxymethyl cellulose for the mixture and precoat layers was higher than that of Comparative Negative Electrode r5 having no precoat layer formed, but was lower than that of Inventive Negative Electrode t6 using the same type of carboxymethyl cellulose for the mixture and precoat layers. It can be seen from the above results that if different types of CMC are used for the mixture and precoat layers, the adhesion strength of the electrode can be increased, but that if the same type of CMC is used for the mixture and precoat layers, the adhesion strength of the electrode can be further increased.

Furthermore, the adhesion strength of Inventive Negative Electrode t6 using as an aqueous dispersant CMC BSH-12 having a degree of etherification of 0.65 to 0.75 was higher than that of Inventive Negative Electrode t2 using as an aqueous dispersant CMC 1380 having a degree of etherification of 1.0 to 1.5. It can be seen from this result that if CMC having a low degree of etherification is used as an aqueous dispersant, the adhesion strength of the electrode can be increased.

[Binder to Active Material Ratio in Interface between Mixture Layer and Current Collector of Negative Electrode]

Inventive Negative Electrode t and Comparative Negative Electrode r1 were measured for the ratio between the binder and the active material in the interface between the mixture layer and the current collector of the negative electrode. In the same manner as in the above-described [Observation of Binder Distribution State], Os was absorbed by double bonds of the binder, and each of the amounts of Os and carbon was measured with an EDX. Thus, the ratio between the binder and the active material was determined. Because the measured amount of carbon contains the amount of carbon in the binder, the amount of active material was calculated by subtracting from the measured amount of carbon the amount of carbon in relation to the amount of binder determined from the amount of Os.

The results are shown in TABLE 5.

TABLE 5

Binder/Active Material (wt %)

| | Inventive Negative | Comparative Negative |
|---|---|---|
| | Electrode t | Electrode r1 |
| Interface | 1.7 | 0.4 |

The solid weight ratio between the binder and the active material in the aqueous slurry (Binder/Active Material) is 1/98, or 1.02% by weight. The solid weight ratio in Inventive Negative Electrode t was 1.70% by weight, which is higher than that in the slurry. On the other hand, the solid weight ratio in Comparative Negative Electrode r1 was 0.4% by weight, which is significantly lower than that in the slurry. It can be seen from these results that by forming a precoat layer according to the present invention, the concentration of binder in the interface between the current collector and the mixture layer of the negative electrode can be increased. Furthermore, it can also be seen that by increasing the concentration of binder in the interface in this manner, the adhesion strength can be increased as shown in TABLE 2.

[Discharge Load Test]

Inventive Battery T and Comparative Battery R1 underwent a single charge-discharge cycle under the following conditions, were then charged again at 1 C and were then discharged to 2.75 V at a constant current of 3 C (2250 mA).

Charge Conditions:

Each battery was charged to 4.20 V at a constant current of 1 C (750 mA) and then charged to a current C/20 (37.5 mA) at a constant voltage of 4.20 V.

Discharge Conditions:

Each battery was discharged to 2.75 V at a constant current of 1 C (750 mA).

Pause:

The time interval between charging and discharging was set at 10 minutes. [0078] The 3 C load characteristics of the batteries were determined, according to the following calculation formula, from the discharge capacities at 3 C and 1 C measured by the above charge-discharge test. The determination results are shown in TABLE 6.

3C Load Characteristic (%)={(Discharge Capacity at 3C)/(Discharge Capacity at 1C)}×100

TABLE 6

| | 3 C Load Characteristic |
|---|---|
| Inventive Battery T | 79.1% |
| Comparative Battery R1 | 79.5% |

As shown in TABLE 6, the load characteristics of Inventive Battery T and Comparative Battery R1 were at a similar level. It can be seen from this that even if according to the present invention a precoat layer is formed on a current collector and a mixture layer is then formed on the precoat layer, the current collectivity is not lowered.

Furthermore, Inventive Batteries T2 and T3 also underwent a discharge load test in the same manner as described above. The results are shown in TABLE 7 together with the results shown in TABLE 6.

TABLE 7

| | 3 C Load Characteristic |
|---|---|
| Inventive Battery T | 79.1% |
| Inventive Battery T2 | 80.3% |
| Inventive Battery T3 | 80.0% |
| Comparative Battery R1 | 79.5% |

As shown in TABLE 7, the load characteristics of Inventive Batteries T2 and T3 were at a similar level to the load characteristic of Comparative Battery R1. Therefore, it can also be seen from the results shown in TABLE 7 that even if according to the present invention a precoat layer is formed on a current collector and a mixture layer is then formed on the precoat layer, the current collectivity is not lowered.

According to the present invention, a high adhesion strength in the electrode can be achieved. Therefore, such a high adhesion strength can inhibit peeling and the like of an active material that would otherwise be caused by repeated charge-discharge cycles, thereby improving the battery performance.

Furthermore, since according to the present invention the electrode can be produced at a high drying temperature as described above, the battery can be efficiently produced.

Although in the above Examples the present invention was applied to the negative electrode, the effects of the present invention can be achieved also if the present invention is applied to the positive electrode.

1. A nonaqueous electrolyte secondary battery including a positive electrode, a negative electrode and a nonaqueous electrolyte, wherein
at least one of the positive electrode and the negative electrode is an electrode obtained by: forming a precoat layer made of a latex binder and an aqueous dispersant on a current collector; forming a mixture layer on the precoat layer by applying an aqueous slurry containing an active material, a latex binder and an aqueous dispersant to the precoat layer; and drying the mixture layer.

2. The nonaqueous electrolyte secondary battery according to claim 1, wherein the latex binder in the precoat layer is the same as that in the mixture layer.

3. The nonaqueous electrolyte secondary battery according to claim 1, wherein the aqueous dispersant in the precoat layer is the same as that in the mixture layer.

4. The nonaqueous electrolyte secondary battery according to claim 1, wherein the weight ratio between the latex binder and the aqueous dispersant in the precoat layer is 1:1 to 5:1.

5. The nonaqueous electrolyte secondary battery according to claim 1, wherein the aqueous dispersant is carboxymethyl cellulose.

6. The nonaqueous electrolyte secondary battery according to claim 3, wherein the aqueous dispersant is carboxymethyl cellulose.

7. The nonaqueous electrolyte secondary battery according to claim 6, wherein the degree of etherification of carboxymethyl cellulose is in the range of 0.5 to 0.8.

8. The nonaqueous electrolyte secondary battery according to claim 1, wherein the thickness of the precoat layer is smaller than that of the mixture layer.

9. The nonaqueous electrolyte secondary battery according to claim 8, wherein the thickness of the precoat layer is 1 μm or less.

10. The nonaqueous electrolyte secondary battery according to claim 1, wherein the electrode is the negative electrode.

11. The nonaqueous electrolyte secondary battery according to claim 1, wherein the concentration of the latex binder in an upper layer of the mixture layer is higher than that of the latex binder in the part of the mixture layer other than the upper layer.

12. A method for manufacturing the nonaqueous electrolyte secondary battery according to claim 1, the method comprising the steps of:
forming the precoat layer on the current collector; and
forming the mixture layer on the precoat layer by applying the aqueous slurry to the precoat layer and then drying the mixture layer.

13. The method for manufacturing the nonaqueous electrolyte secondary battery according to claim 12, wherein the step of forming the precoat layer comprises the step of applying an aqueous solution containing a latex binder for forming the precoat layer and the aqueous dispersant to the current collector and then drying the aqueous solution.
